(19) United States
(12) Patent Application Publication
(10) Pub. No.: US 2024/0135455 A1
(43) Pub. Date: Apr. 25, 2024

(54) SYSTEM AND METHOD FOR THE DYNAMIC ALLOCATION OF FUNDS

(71) Applicant: Capital One Services, LLC, McLean, VA (US)

(72) Inventors: Xiaoguang ZHU, New York, NY (US); Samuel RAPOWITZ, Roswell, GA (US); Lin Ni Lisa CHENG, Fresh Meadows, NY (US)

(21) Appl. No.: 17/972,424

(22) Filed: Oct. 23, 2022

(51) Int. Cl. G06Q 40/06

(52) U.S. Cl. CPC G06Q 40/06

(57) ABSTRACT

The disclosed embodiments include a system and method for generating a predictive model and allocating, based on the model's findings, an ideal amount into a user's account. The system includes a user device and a server. The server can retrieve the user's information, analyze the information, generate the predictive model, train the model, calculate a savings amount and allocate the amount to the appropriate account.

### FIELD OF DISCLOSURE

The present disclosure relates generally to generating a predictive model, calculating an apportionment of funds, and allocating said funds according to the predictive model.

### BACKGROUND

Automatic deductions are one of the best ways to save money. A user can elect to make automatic deductions from their income, such as their salaried income. The deductions can be made for retirements funds, health savings accounts, general savings accounts, and other investments. Because these deductions can be taken automatically from the user's income payments, the user does not have to manually allocate their income payment at the end of every pay period. This prevents the user from forgetting to allocate their income payment, and over time the user will see more allocations put toward their financial goals.

However, users are rarely given any direction when deciding how much of their income payments should go towards their savings. Moreover, when users set up their automatic deductions, they rarely change the deduction amount even after a significant financial event occurs, e.g. the user gets promoted or buys a home. Consequently, users can easily over- or under-estimate their ideal deduction amount.

These and other deficiencies exist. Therefore, there is a current demand for a unique system and method not only to determine how large the deductions should be, but also to adjust these deductions automatically when a significant financial event occurs.

### SUMMARY OF THE DISCLOSURE

Embodiments of the present disclosure provide a system for creating and applying a predictive model for the dynamic allocation of a spend account associated with a user, the system comprising a data storage unit configured to store financial information associated with the user, and a processor. The processor is configured to allocate a spending amount to a user for a payment period. To achieve this, the processor is further configured to retrieve financial information associated with a user and store, after retrieval, the financial information in the data storage unit. Upon storing the information in the data storage unit, the processor can separate the financial information into one or more categories, then analyze the trends in the separated financial categories. Next, the processor can generate, after analyzing the trends in the financial categories, a predictive model configured to determine a spending amount the user needs for a pay period wherein the predictive model comprises a model of the user's future spending habits anticipated by a predetermined algorithm. Once the predictive model has been generated, the processor can update the predictive model with new financial information associated with the user wherein the financial information has been retrieved and stored in the data storage unit. Next, the processor can calculate, by a predetermined algorithm, a spending amount that that the user needs for the pay period. Finally, the processor can allocate, after calculating the spending amount, the spending amount in the user's spending account for the pay period.

Embodiments of the present disclosure also provide a method for creating and applying a predictive model for the dynamic allocation of a spend account associated with a user. The steps include the following: retrieving financial information associated with an user; separating, after retrieval, the financial information into one or more categories; storing, by a processor, the financial information in the data storage unit; analyzing, by a processor, trends in the financial categories; generate, after analyzing the trends in the financial categories, a predictive model configured to determine a spending amount the user needs for a pay period wherein the predictive model comprises a model of the user's future spending habits anticipated by a predetermined algorithm; updating, by a processor, the predictive model with new financial information associated with the user wherein the financial information has been retrieved and stored in the data storage unit; calculating, after applying the predictive model, a spending amount that that the user needs for the pay period; and allocating, after calculating the spending amount, the spending amount in the user's spending account for the pay period.

Embodiments of the present disclosure provide a computer readable non-transitory medium comprising computer executable instructions that, when executed on a processor, perform procedures comprising the following steps: retrieving financial information associated with an user; separating, after retrieval, the financial information into one or more categories; storing, by a processor, the financial information in the data storage unit; analyzing, by a processor, trends in the financial categories; generate, after analyzing the trends in the financial categories, a predictive model configured to determine a spending amount the user needs for a pay period wherein the predictive model comprises a model of the user's future spending habits anticipated by a predetermined algorithm; updating, by a processor, the predictive model with new financial information associated with the user wherein the financial information has been retrieved and stored in the data storage unit; calculating, after applying the predictive model, a spending amount that that the user needs for the pay period; and allocating, after calculating the spending amount, the spending amount in the user's spending account for the pay period.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a system according to an exemplary embodiment.

FIG. 2 is a method diagram illustrating a method according to an exemplary embodiment.

FIG. 3 is a method diagram illustrating a shadow model process according to an exemplary embodiment.

FIG. 4 is a method diagram illustrating a process for generating and enforcing a spending limit.

FIG. 5 is a method diagram illustrating a process for generating a savings account for the user.

FIG. 6 is a diagram illustrating a neural network as an exemplary embodiment for the predictive model.

FIG. 7 is a flowchart illustrating the generation of a predictive model and the calculating of a coverage amount.

FIG. 8 is a method flowchart illustrating a process for recognizing a significant financial change, requesting the user for an approval to change the deduction amount, and allocating the deduction.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Generally, the disclosed embodiments describe a system and method for analyzing a user's information, creating a predictive model, generating an ideal spend amount based on the findings from the predictive model, and automatically allocating the ideal spend amount into the correct account. Also, the predictive model can generate a unique account if certain parameters are met. For example, the predictive model can create a savings account or a retirement account for the user. The savings account can be made for a specific purpose like saving for a down payment on a home, or the savings account can be made for general purposes savings. Unlike other automatic deductions systems, the disclosed system can change the deducted amount automatically if certain parameters change. For example, the model may adjust the automatic deduction if the user switches careers, pays a large medical bill, opens a college savings account, or makes other significant financial decisions.

The predictive model improves upon existing systems by offering a more robust method of saving money. Ultimately, users enjoy a unique deduction system that caters exactly to their past, present, and future spending habits. This results in a more financially stable user by protecting against over- or under-saving. As an example, the model can help prevent the user from under-saving in preparation for a large purchase like an automobile or engagement ring. On the flip side, the model can also help prevent the user from over-saving in a situation where funds could be better spent on investments or other purchases.

Also, this system and method saves the user a significant amount of time and energy. Rather than manually change the automatic deduction every time something financially significant happens, the user can rely on the predictive model to make a necessary adjustment. This not only saves time but also grants the user greater peace of mind.

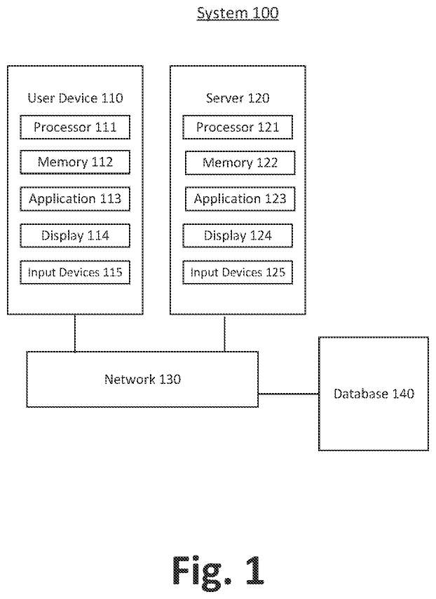

FIG. 1 illustrates a system according to an exemplary embodiment. The system 100 may comprise a user device 110, a server 120, a network 130, and a database 140. Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 110 may include a processor 111, a memory 112, and an application 113. The processor 111 may be a processor, a microprocessor, or other processor, and the user device 110 may include one or more of these processors. The processor 111 may include processing circuitry, which may contain additional components, including additional processors, memories, error and parity and/or CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's private data and financial account information.

The application 113 may comprise one or more software applications, such as a mobile application and a web browser, comprising instructions for execution on the user device 110. In some examples, the user device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described below. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touch-screen, keyboard, mouse, cursor-control device, touch-screen, microphone, digital camera, video recorder or camcorder. These devices may be used to enter information and interact with the software and other devices described herein.

System 100 may include a server 120. The server 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 120 may include a processor 121, a memory 122, and an application 123. The processor 121 may be a processor, a microprocessor, or other processor, and the server 120 may include one or more of these processors. The processor 121 may include processing circuitry, which may contain additional components, including additional processors, memories, error and parity and/or CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the server 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications comprising instructions for execution on the server 120. In some examples, the server 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. For example, the application 123 may be executed to perform receiving web form data from the user device 110, retaining a web session with the user device 110, and masking private data received from the user device 110. Such processes may be implemented in software, such as software modules, for execution by computers or other machines. The application 123 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the server 120 that is available and supported by the server 120, such as a touch-screen, keyboard, mouse, cursor-control device, touch-screen, microphone, digital camera, video recorder or camcorder. These devices may be used to enter information and interact with the software and other devices described herein.

System 100 may include one or more networks 130. In some examples, the network 130 may be one or more of a wireless network, a wired network or any combination of wireless network and wired network, and may be configured to connect the user device 110, the server 120, and the database 140. For example, the network 130 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 130 may include, without limitation, telephone lines, fiber optics, IEEE Ethernet 902.3, a wide area network, a wireless personal area network, a LAN, or a global network such as the Internet. In addition, the network 130 may support an Internet network, a wireless communication network, a cellular network, or the like, or any combination thereof. The network 130 may further include one network, or any number of the exemplary types of networks mentioned above, operating as a stand-alone network or in cooperation with each other. The network 130 may utilize one or more protocols of one or more network elements to which they are communicatively coupled. The network 130 may translate to or from other protocols to one or more protocols of network devices. Although the network 130 is depicted as a single network, it should be appreciated that according to one or more examples, the network 130 may comprise a plurality of interconnected networks, such as, for example, the Internet, a service provider's network, a cable television network, corporate networks, such as credit card association networks, and home networks. The network 130 may further comprise, or be configured to create, one or more front channels, which may be publicly accessible and through which communications may be observable, and one or more secured back channels, which may not be publicly accessible and through which communications may not be observable.

System 100 may include a database 140. The database 140 may be one or more databases configured to store data, including without limitation, private data of users, financial accounts of users, identities of users, transactions of users, and certified and uncertified documents. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the server 120 or may be hosted externally of the server 120, such as by a server, by a cloud-based platform, or in any storage device that is in data communication with the server 120.

In some examples, exemplary procedures in accordance with the present disclosure described herein can be performed by a processing arrangement and/or a computing arrangement (e.g., computer hardware arrangement). Such processing and/or computing arrangement can be, for example entirely or a part of, or include, but not limited to, a computer and/or processor that can include, for example one or more microprocessors, and use instructions stored on a non-transitory computer-readable medium (e.g., RAM, ROM, hard drive, or other storage device). For example, a computer-readable medium can be part of the memory of the user device 110, server 120, database 140, or other computer hardware arrangement.

In some examples, a computer-readable medium (e.g., as described herein, a storage device such as a hard disk, floppy disk, memory stick, CD-ROM, RAM, ROM, etc., or a collection thereof) can be provided (e.g., in communication with the processing arrangement). The computer-readable medium can contain executable instructions thereon. In addition or alternatively, a storage arrangement can be provided separately from the computer-readable medium, which can provide the instructions to the processing arrangement so as to configure the processing arrangement to execute certain exemplary procedures, processes, and methods, as described herein above, for example.

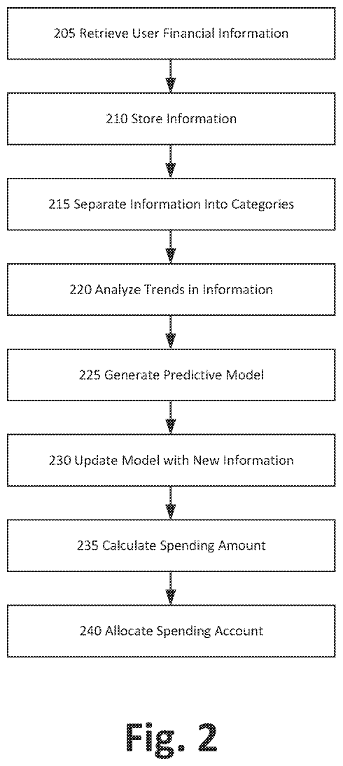

FIG. 2 is a method diagram illustrating a method according to an exemplary embodiment. Generally, this method can be performed by a processor associated with a user device or server.

In action 205, the processor retrieves financial information associated with the user. The financial information may be provided by the user, the user's employer, the user's banking institution, or any third-party system that accesses the user's information. For example, the financial information can be retrieved from the user's checking and savings accounts associated with one or more banking institutions. As another nonlimiting example, the processor may retrieve information from a third party application such as a financial planning application. The financial information can include without limitation past and present income, future expected income, credit history, asset history, investment history, tax history, savings history, spending habits or patterns, financial goals, student loan debt, housing debt, credit card debt, and other debts. Spending habits or spending patterns can include how much is spent on certain products or services in a given pay period. For example, a spending pattern can reveal that the user spends fifty percent of their income on rent, twenty percent on food, ten percent on traveling, and twenty percent on other consumer goods. As another example, a spending habit can reveal that the user spends more of their income on gifts and traveling during the holiday season. Financial information can also include the user's self-reported financial agenda, such as a plan to buy a house, buy a car, save for an education, save for a wedding, save for children, getting a raise, getting a promotion, switching careers, taking a sabbatical, and other significant financial events. It is understood that other information besides financial information can be retrieved, such as marital status, children status, education status, employment status, geographic location, and zip code. It is also understood that this information can be provided the by the user's employer. As a nonlimiting example, the employer can provide information associated with the user's career, 401(k), health savings account (HSA), IRA accounts, 529 accounts, custodial accounts, other savings accounts, and other investment accounts.

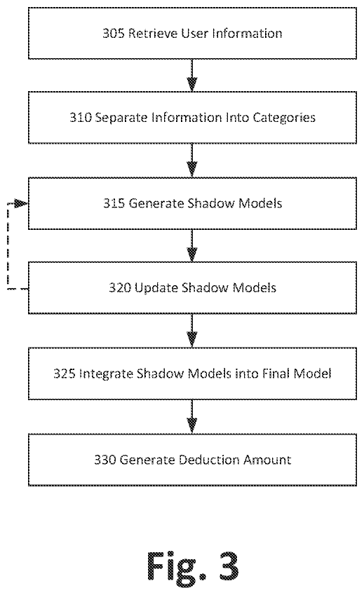

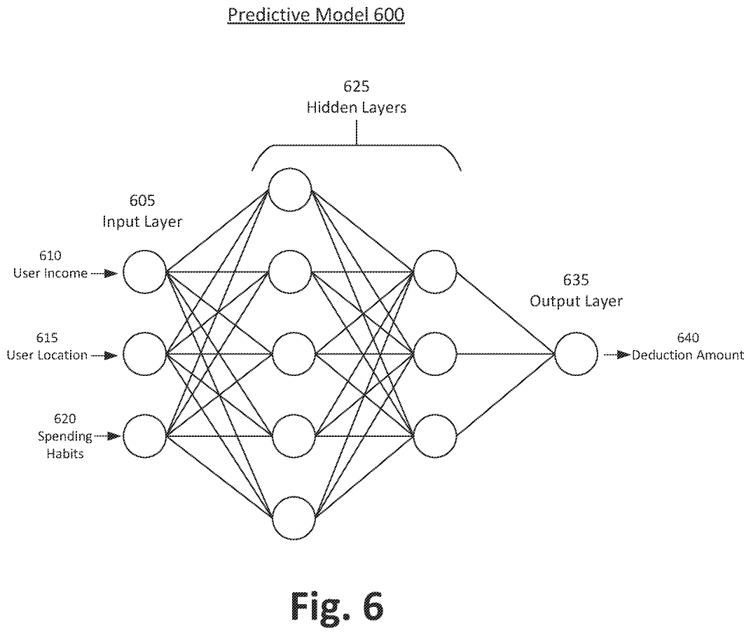

Once the financial information has been retrieved, the information can be stored in action 210. The information can be stored in a database or data storage unit associated with the server. In action 215, the financial information can be separated into categories by a processor associated with the user device or server. The information can be retrieved from the database. Alternatively, the financial information can be categorized prior to be stored in the database. The categories may be predetermined by the user or the predictive model. As a nonlimiting example, the categories can include income information, housing information, future spending goals, and past spending history. These categories may be adjusted by the user or the predictive model according to the needs of the model. For example, the user may want to provide the user other potentially useful information such as their social media profile. In action 220, the processor can analyze the trends in the gathered information. These trends may be observed within a predetermined agenda set by the user or the server. For example, the processor can find an uptrend in spending on travel and gifts. As another example, the processor can find a downtrend in spending on food and appliances. As another example, the processor can find that the user is spending less and saving more overall. The analysis can be performed by one or more neural networks or related shadow models discussed with further reference to FIG. 3 and FIG. 6. After a sufficient analysis has been performed, in action 225 the processor can generate a predictive model. The predictive model can be configured to produce a most efficient spending amount according to the parameters set by the user or the server. It is understood that the predictive model can undergo a number of iterations before an acceptable output is reached. It is also understood that the predictive model can be configured to make a number of different inputs including but not limited to a spending amount, a savings amount, an investment amount, a decision of whether to open a savings account, and other financial suggestions. Having generated the predictive model, in action 230 the predictive can be updated with new information. The new information can be retrieved by the processor associated with the user device or the server. Once new information is fed into the model, the model can re-train or update itself. The resulting outputs can change according to these new inputs. It is understood that the model can be continuously updated with new information, including new types of information that were not considered previously. The user or the server can suggest new types of information be added or deleted from the analysis.

Once the predictive model has been sufficiently updated, in action 235 the predictive model calculates a spending amount. The spending amount can include an amount deducted from a user's paycheck for a certain pay period. Alternatively, the spending amount may include an amount that is already sitting in spending or savings account associated with the user. In action 240, the processor can allocate the spending amount into a predetermined spending account set by the user. The spending account can be associated with a checking account. Alternatively, the spending amount may be allocated to other accounts such as savings account or investing accounts. The user can receive one or more alerts when the spending amount has been allocated.

FIG. 3 is a method diagram illustrating a shadow model process according to an exemplary embodiment.

To generate a more accurate predictive model, one or more shadow models can be made, trained, and integrated into the final predictive model. In actions 305 and 310, information associated with the user is retrieved and separated into the categories. These actions can be performed by a processor associated with the user device or the server. The financial information may be provided by the user, the user's employer, the user's banking institution, or any third-party system that accesses the user's information. For example, the financial information can be retrieved from the user's checking and savings accounts associated with one or more banking institutions. As another nonlimiting example, the processor may retrieve information from a third party application such as a financial planning application. The financial information can include without limitation past and present income, future expected income, credit history, asset history, investment history, tax history, savings history, spending habits, financial goals, student loan debt, housing debt, credit card debt, and other debts. Spending habits or spending patterns can include how much is spent on certain products or services in a given pay period. For example, a spending pattern can reveal that the user spends fifty percent of their income on rent, twenty percent on food, ten percent on traveling, and twenty percent on other consumer goods. As another example, a spending habit can reveal that the user spends more of their income on gifts and traveling during the holiday season. Financial information can also include the user's self-reported financial agenda, such as a plan to buy a house, buy a car, save for an education, save for a wedding, save for children, getting a raise, getting a promotion, switching careers, taking a sabbatical, and other significant financial events. It is understood that other information besides financial information can be retrieved, such as marital status, children status, education status, employment status, geographic location, and zip code. It is also understood that this information can be provided the by the user's employer. As a nonlimiting example, the employer can provide information associated with the user's career, 401(k), health savings account (HSA), IRA accounts, 529 accounts, custodial accounts, other savings accounts, and other investment accounts.

In actions 315 and 320, the processor can generate one or more shadow models that are trained and updated until a predetermined criteria has been met. Generally, a shadow model can be a predictive model derived from existing predictive models through model-to-model transformations. Shadow modeling can include new developed versions of predictive model that are not used to provide outputs back to the customers, but rather serve as a developing model in its early stages of training. As a nonlimiting example, an existing predictive model continues to serve its purposes to customers while the shadow model is merely updated and stored for later analysis. The shadow models can undergo a number of iterations before finally meeting a predetermined criterion. Shadow models offer an efficient way to train the predictive model to analyze new inputs and produce different outputs. For example, shadow models can provide a robust testing environment for new data or new data categories. As a nonlimiting example, a shadow model can be created to test the model's understanding of marital status as it relates to the spending amount. This new category can be analyzed in the shadow model for many iterations before being integrated into the main predictive model. Shadow models can include neural networks discussed with further reference to FIG. 6. Actions 315 and 320 can be repeated until a predetermined criteria has been met, such as a desired output associated with the spending amount. Once created, the shadow models can be stored in the database or data storage unit for further analysis. If the shadow model has been sufficiently trained, in action 325 it can be integrated into the final model at which point the deduction or spending amount can be generated in action 330.

It is understood that, even after the deduction amount has been generated, more shadow models can be created, trained, and integrated into the final predictive model.

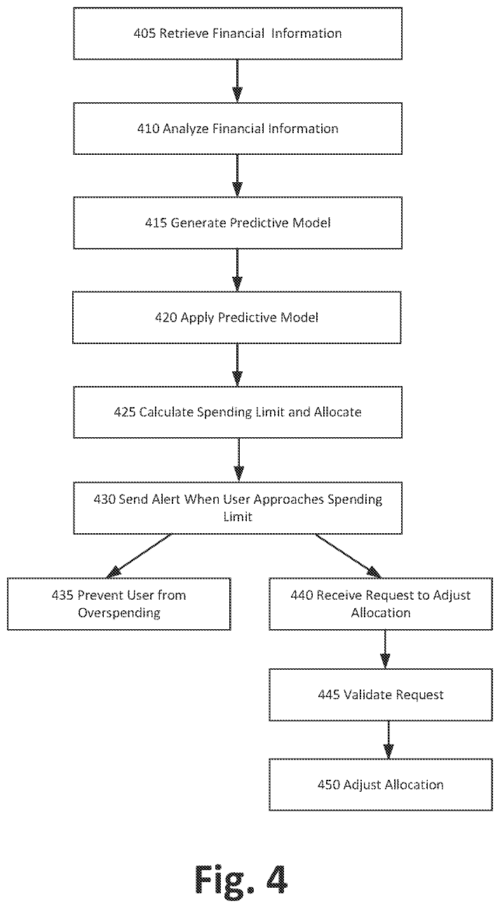

FIG. 4 is a method diagram illustrating a process for generating and enforcing a spending limit.

In action 405, the processor associated with the user device or server can retrieve user information. The financial information may be provided by the user, the user's employer, the user's banking institution, or any third-party system that accesses the user's information. For example, the financial information can be retrieved from the user's checking and savings accounts associated with one or more banking institutions. As another nonlimiting example, the processor may retrieve information from a third party application such as a financial planning application. The financial information can include without limitation past and present income, future expected income, credit history, asset history, investment history, tax history, savings history, spending habits, financial goals, student loan debt, housing debt, credit card debt, and other debts. Financial information can also include the user's self-reported financial agenda, such as a plan to buy a house, buy a car, save for an education, save for a wedding, save for children, getting a raise, getting a promotion, switching careers, taking a sabbatical, and other significant financial events. It is understood that other information besides financial information can be retrieved, such as marital status, children status, education status, employment status, geographic location, and zip code. It is also understood that this information can be provided the by the user's employer. As a nonlimiting example, the employer can provide information associated with the user's career, 401(k), health savings account (HSA), IRA accounts, 529 accounts, custodial accounts, other savings accounts, and other investment accounts. In action 410, the financial information is analyzed by the processor. The analysis may take the form of neural network analysis discussed with further reference to FIG. 6. In action 415, the predictive model is generated. The predictive model can be the result of several shadow models discussed with further reference to FIG. 3.

In actions 420 and 425, the predictive model is applied to calculate a spending limit. The predictive model can receive a predetermined number of inputs such as the information described above. Upon applying the predictive model, the model can calculate a spending limit congruent with the user's financial agenda. Having calculated the spending amount, the processor can allocate the amount into a spending account associated with the user's banking institution.

In action 430, the processor may send an alert to the user when the user is approaches the spending limit. The alert can include a message sent over a network to the user device. The alert may be sent from a third party web application that is responsible for monitoring the user's spending habits. Following the alert, the user may attempt to spend over the calculated spending limit. As a result, in action 435 the processor can prevent the user from overspending. The processor can, in concert with the user's spending account, freeze the money in the user's spending account so that the user may not spend over the limit. Alternatively, in action 440 the processor can receive a request to adjust the spend amount from the user device. The request can be sent over a network. The request can be sent in response to the alert from action 430. In response to the request to adjust the allocation, the processor may ask the user to validate their request with a credential. The credential can include without limitation a name, email, temporary PIN number, password, security question, contactless card, digital signature, or some biometric including without limitation a fingerprint scan, facial scan, or voice scan. In action 445, the server can validate the credential. As a nonlimiting example, the server can validate the credential by matching the credential with user information on file. Once the request is validated, in action 450 the processor can adjust the allocation to increase the spending limit. It is understood that the spending limit may be adjusted a number of times.

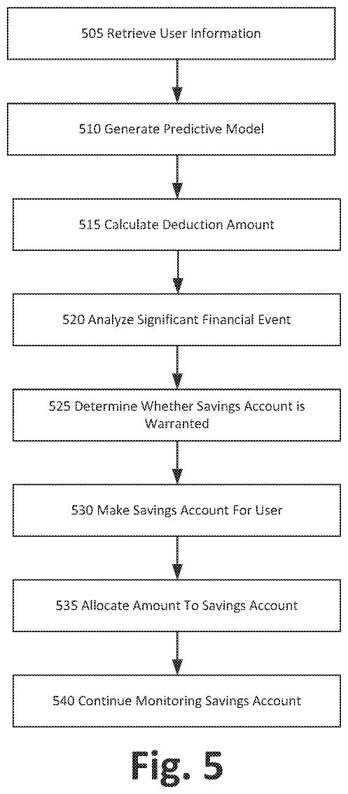

FIG. 5 is a method diagram illustrating a process for generating a savings account for the user.

In action 505, the processor may retrieve user information and related financial information. The financial information may be provided by the user, the user's employer, the user's banking institution, or any third-party system that accesses the user's information. For example, the financial information can be retrieved from the user's checking and savings accounts associated with one or more banking institutions. As another nonlimiting example, the processor may retrieve information from a third party application such as a financial planning application. The financial information can include without limitation past and present income, future expected income, credit history, asset history, investment history, tax history, savings history, spending habits, financial goals, student loan debt, housing debt, credit card debt, and other debts. Spending habits or spending patterns can include how much is spent on certain products or services in a given pay period. For example, a spending pattern can reveal that the user spends fifty percent of their income on rent, twenty percent on food, ten percent on traveling, and twenty percent on other consumer goods. As another example, a spending habit can reveal that the user spends more of their income on gifts and traveling during the holiday season. Financial information can also include the user's self-reported financial agenda, such as a plan to buy a house, buy a car, save for an education, save for a wedding, save for children, getting a raise, getting a promotion, switching careers, taking a sabbatical, and other significant financial events. It is understood that other information besides financial information can be retrieved, such as marital status, children status, education status, employment status, geographic location, and zip code. It is also understood that this information can be provided the by the user's employer. As a nonlimiting example, the employer can provide information associated with the user's career, 401(k), health savings account (HSA), IRA accounts, 529 accounts, custodial accounts, other savings accounts, and other investment accounts. In action 410, the financial information is analyzed by the processor. The analysis may take the form of neural network analysis discussed with further reference to FIG. 6. In action 415, the predictive model is generated. The predictive model can be the result of several shadow models discussed with further reference to FIG. 3.

In actions 510 and 515, the financial information is used to generate a predictive model and calculate an ideal deduction amount. This action can be performed by a processor associated with the server or user device. The predictive model can include a neural network discussed with further reference to FIG. 6. The predictive model can be configured to produce a most efficient spending amount according to the parameters set by the user or the server. It is understood that the predictive model can undergo a number of iterations before an acceptable output is reached. It is also understood that the predictive model can be configured to make a number of different inputs including but not limited to a spending amount, a savings amount, an investment amount, a decision of whether to open a savings account, and other financial suggestions. The predictive model can be trained a number of times. Additionally, shadow models may be used to train or otherwise analyze new information. Shadow models are discussed with further reference to FIG. 3.

In action 520, the processor can analyze a significant financial event that has occurred in relation to the user. The processor can observe a financial event by monitoring the user's spending habits or by being provided new information by the user. A significant financial event can be an event that will likely affect the user's present spending ability and future spending habits. Significant financial events can include without limitation a new career path, a plan to purchase a home or car, a plan to save for children, a plan to move to a new country, or some other event that likely precedes a change in spending habits. In action 525, the processor can determine whether a savings account should be made in response to the new significant financial event. This determination can include without limitation a predetermined set of parameters such as the user's financial goals, comfort with debt, and retirement goals. If the processor determines that a savings account would be beneficial, in action 530 the processor may create a savings account for the user. The savings account may be opened in connection with the user's existing accounts at an existing banking institution. Alternatively, the processor may create a savings account in a third-party application. As another nonlimiting example, the processor may open a 401(k) or IRA account in connection with the user's employer. Once the savings account has been created, the processor can allocate the amount to the savings account in action 535. The processor may continue to monitor the savings account in action 540 according to the user's financial goals.

FIG. 6 is a diagram illustrating a neural network as an exemplary embodiment for the predictive model.

A neural network is a series of algorithms that can, under predetermined training restrictions, recognize relationships between one or more variables. A neuron in a neural network is a mathematical function that collects and classifies information according to a specific form set by a user. Generally, a neural network can be divided into three main components: an input layer, a processing or hidden layer, and an output layer. The input layer comprises data sets chosen to be inserted into the neural network for analysis. The hidden layers include one or more neurons that can classify the inputs according to parameters set by the user. The hidden layers can comprise multiple successive layers, the first layer positioned immediately after the input layer and the last layer positioned immediately before the output layer. The hidden layer immediately after the input layer may be connected to the input layer via a predetermined weight or emphasis. These weights can be assigned according to the modeler's agenda. Alternatively, the model itself can determine the optimal weights between layers such that a predetermined outcome, margin of error, or minimum data point is achieved.

The predictive model can comprise a neural network 600. The neural network may be integrated into the server, the user device, or some other computer device suitable for neural network analysis. The neural network can include generally an input layer 605, one or more hidden layers 625, and an output layer 635. Although only a certain number of nodes are depicted in FIG. 6, it is understood that the neural network according to the disclosed embodiments may include less or more nodes in each layer. Additionally, the hidden layers can include more or less layers than what is depicted in FIG. 6. It is also understood that the connections between each layer may be assigned a predetermined weight according to user's manual change or according to some weight value generated by the neural network itself. The input layer may include sets of data gathered from outside sources. The neural network can include the user's financial information including user income 610, user location 615, and spending habits 620. Spending habits or spending patterns can include how much is spent on certain products or services in a given pay period. For example, a spending pattern can reveal that the user spends fifty percent of their income on rent, twenty percent on food, ten percent on traveling, and twenty percent on other consumer goods. As another example, a spending habit can reveal that the user spends more of their income on gifts and traveling during the holiday season. Other inputs not depicted in FIG. 6 may also comprise inputs such as historical information related to the user's financial information. The financial information can include without limitation past and present income, future expected income, credit history, asset history, investment history, tax history, savings history, spending habits, financial goals, student loan debt, housing debt, credit card debt, and other debts. Financial information can also include the user's self-reported financial agenda, such as a plan to buy a house, buy a car, save for an education, save for a wedding, save for children, getting a raise, getting a promotion, switching careers, taking a sabbatical, and other significant financial events. It is understood that other information besides financial information can be retrieved, such as marital status, children status, education status, employment status, geographic location, and zip code. It is also understood that this information can be provided the by the user's employer. As a nonlimiting example, the employer can provide information associated with the user's career, 401(k), health savings account (HSA), IRA accounts, 529 accounts, custodial accounts, other savings accounts, and other investment accounts. The neurons associated with the hidden layers can be trained or provisioned to classify the inputs according to parameters set by the user. Upon analyzing the inputs via the one or more hidden layers, the neural network can create an output or deduction amount 640. It is understood that the neural network can be provisioned to create other outputs such as a spending amount, savings amount, investment amount, or some other deduction that meets the user's financial goals. It is understood that one or more neural networks or some combination of neural networks can be trained according to individual users, user within a certain geographic limit, income limit, age limit, or user associated with a specific employer.

The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-readable medium can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse, and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

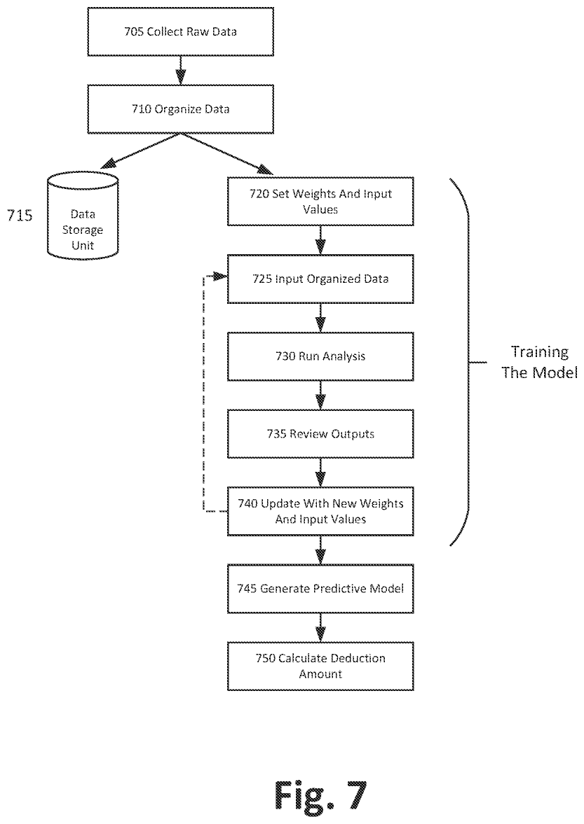

FIG. 7 is a flowchart illustrating the generation of a predictive model and the calculating of a coverage amount.

The process 700 describes the training process for an exemplary predictive model or neural network suitable for predicting and calculating a deduction amount associated with a user. The process can begin with action 705 when raw data is collected. The raw data can be associated with the user's financial information. Financial information can include without limitation past and present income, future expected income, credit history, asset history, investment history, tax history, savings history, spending habits, financial goals, student loan debt, housing debt, credit card debt, and other debts. Financial information can also include the user's self-reported financial agenda, such as a plan to buy a house, buy a car, save for an education, save for a wedding, save for children, getting a raise, getting a promotion, switching careers, taking a sabbatical, and other significant financial events. It is understood that other information besides financial information can be retrieved, such as marital status, children status, education status, employment status, geographic location, and zip code. It is also understood that this information can be provided the by the user's employer. As a nonlimiting example, the employer can provide information associated with the user's career, 401(k), health savings account (HSA), IRA accounts, 529 accounts, custodial accounts, other savings accounts, and other investment accounts. The collection of raw data can be performed by a processor or application associated with the user device or server. The raw data can be transmitted over a wired or wireless network. The data may have been previously gathered and stored in a database or data storage unit in which case the processor or application can retrieve the data from the data storage unit. At action 710, the processor or application can organize the raw data into discernable categories including but not limited to income information, housing information, future spending goals, and past spending history. These categories may be adjusted by the user or the predictive model according to the needs of the model. For example, the user may want to provide the user other potentially useful information such as their social media profile. The categories can be predetermined by the user or created by the predictive model. At action 715, the organized or raw data can be transmitted to the data storage unit. The data storage unit can be associated with the user device or server. The raw or organized data can be transmitted over a wired network, wireless network, or one or more express buses. Upon organizing the data into one or categories, the processor or application can proceed with training the predictive model in actions 720 through 740. Generally, the training portion can have any number of iterations. The predictive model can comprise one or more neural network described with further reference to FIG. 6.

The training portion can begin with action 720 when the weights and input values are set by the user or by the model itself. Furthermore, the weights can be the predetermined connections between the inputs and the hidden layers described with further reference to FIG. 6. The input values are the values that are fed into the neural network. The input values may be discerned by the different categories created in action 710, although other distinct input values may be discerned. In action 725, the data in inputted in the neural network, and in action 730 the neural network analyzes the data according to the weights and other parameters set by the user. As a nonlimiting, example, the user may create the stipulation that the deduction amount must be at least ten dollars. In action 735, the outputs are reviewed. The outputs can include one or more spending amounts, saving amounts, or investing amounts. In action 740, the predictive model may be updated with new data and parameters. The new data can be collected by the processor in a similar fashion to actions 705 and 710. Though it is not necessary in this exemplary embodiment to retrain the predictive model, the predictive model can be re-trained any number times such that actions 725 through 740 are repeated until a satisfactory output is achieved or some other parameter has been met. As a nonlimiting example, the user may update the inputs with new financial data. As another nonlimiting example, the user can adjust the weighted relationship between the input layer and the one or more hidden layers of a neural network discussed with further reference to FIG. 6. If a satisfactory output has been recorded, then in action 745 one or more predictive models can be generated. It is understood that the predictive model, once generated, can undergo further training similar to actions 720 to 745. Having generated the predictive model, in action 750 the model can calculate a coverage amount given the unique input values collected from the user.

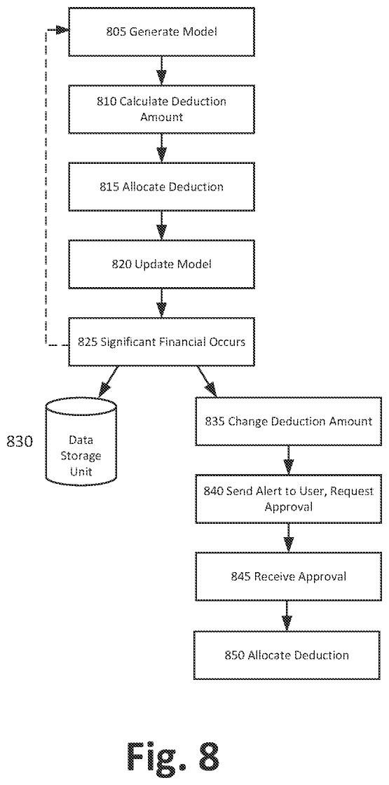

FIG. 8 is a method flowchart illustrating a process for recognizing a significant financial change, requesting the user for an approval to change the deduction amount, and allocating the deduction.

In actions 805 through 825, a predictive model is created. In action 805, a processor generates the model. The generation of the predictive model is discussed with further reference to FIGS. 2-6. Once the model is generated, the model can calculate a deduction amount in action 810 and allocated in action 815. This action can be performed by a processor. The deduction can be allocated to an account associated with the user's banking institution, such as a spending amount, savings account, or investment account. In action 820, the predictive model can be updated with new input information. The model can be updated continuously with new information. The model can be subject to multiple iterations discussed with further reference to FIG. 6.

In action 825, a significant financial event occurs. A significant financial event can include a plan to buy a house, buy a car, save for an education, save for a wedding, save for children, getting a raise, getting a promotion, switching careers, and taking a sabbatical. The significant event can be observed the processor associated with the server. Upon recognizing that a significant financial event has occurred, the observation of the event may be stored in a data storage unit for later analysis in action 830. This action can be performed by a processor. Additionally, the significant event itself may be analyzed by the predictive model which can, in turn, calculate a new coverage amount in light of the event. In action 835, the new deduction amount can be calculated by the processor. As a nonlimiting example, the deduction amount may be decreased so that the user can allocate more towards spending than saving. In action 840, the processor sends an alert to the user and request their approval to allocate the new deduction amount. This action can be performed by a processor. The alert may be sent over a network. In response to the alert, the server may receive approval from the user in action 845. The approval can include a verification credential including without limitation a name, password, email, biometric, or card information. Once approval has been received, the processor can allocate the deduction in action 850. The deduction can be allocated into a predetermined account such as a checking, savings, or investment account. Additionally, the amount can be saved in an account associated with a third party application.

In some aspects, the techniques described herein relate to a system for predictive modeling of a dynamic allocation of a spend account associated with a user, the system including: a data storage unit configured to store financial information associated with a user; and a processor configured to allocate a spending amount to the user for a payment period, wherein the processor is further configured to: retrieve financial information associated with the user; store, after retrieval, the financial information in the data storage unit; separate, after storage, the financial information into one or more categories; analyze, after separating the financial information into categories, one or more trends in the separated financial categories; generate, after analyzing the trends in the financial categories, a predictive model configured to determine a spending amount the user needs for a pay period wherein the predictive model includes a model of the user's future spending habits anticipated by a predetermined algorithm; update, by the processor, the predictive model with new financial information associated with the user wherein the financial information has been retrieved and stored in the data storage unit; calculate, by a predetermined algorithm, a spending amount that that the user needs for the pay period; and allocate, after calculating the spending amount, the spending amount to the user for the pay period.

In some aspects, the techniques described herein relate to a system, wherein prior to the generation of the predictive model, the processor is configured to: generate, in response to the analysis of the separate financial categories, one or more shadow models configured to predict a spending amount by a predetermined algorithm; update the one or more shadow models with new financial information associated with the user; and integrate the shadow models into the predictive model to improve the accuracy of the predictive model.

In some aspects, the techniques described herein relate to a system, wherein the processor is further configured to retrieve information from the user's checking and savings account from one or more banks associated with the user.

In some aspects, the techniques described herein relate to a system, wherein after the spending amount has been allocated, the processor is further configured to create a savings account associated with the user based on the financial information associated with the user.

In some aspects, the techniques described herein relate to a system, wherein the processor is further configured to retrieve information from third party applications associated with the user's financial history.

In some aspects, the techniques described herein relate to a system, wherein prior to allocating the spending amount, the processor is further configured to adjust the spending amount based on manual change done by the user.

In some aspects, the techniques described herein relate to a system, wherein the processor is further configured to disallow the user from spending beyond the spending amount.

In some aspects, the techniques described herein relate to a system, wherein the information associated with the user includes at least one selected from the group of marital status, children status, and education status.

In some aspects, the techniques described herein relate to a method for predictive modeling of a dynamic allocation of a spend account associated with a user, the method including the steps: retrieving financial information associated with a user; separating, after retrieval, the financial information into one or more categories; storing, by a processor, the financial information in a data storage unit; analyzing, by the processor, trends in the financial categories; generate, after analyzing the trends in the financial categories, a predictive model configured to determine a spending amount the user needs for a pay period wherein the predictive model includes a model of the user's future spending habits anticipated by a predetermined algorithm; updating, by the processor, the predictive model with new financial information associated with the user wherein the financial information has been retrieved and stored in the data storage unit; calculating, after applying the predictive model, a spending amount that that the user needs for the pay period; and allocating, after calculating the spending amount, the spending amount to the user for the pay period.

In some aspects, the techniques described herein relate to a method, wherein prior to the generation of the predictive model, the steps further include: generating, in response to the analysis of the separate financial categories, one or more shadow models configured to predict a spending amount; updating, by a processor, the one or more shadow models with new financial information associated with the user; and integrating, by a processor, the shadow models into the predictive model to improve the accuracy of the predictive model.

In some aspects, the techniques described herein relate to a method, wherein the steps further include retrieving information from third party applications associated with the user's financial history.

In some aspects, the techniques described herein relate to a method, wherein the information associated with a user include at least one selected from the group of employment status, geographic location, and zip code.

In some aspects, the techniques described herein relate to a method, wherein the financial information associated with the user includes at least one selected from the group of debt information, prior transaction information, and spending pattern information.

In some aspects, the techniques described herein relate to a method, wherein after allocating the spending amount, the steps further include creating a savings account associated with the user based on the information gathered.

In some aspects, the techniques described herein relate to a method, wherein the steps further include retrieving information associated with future earnings.

In some aspects, the techniques described herein relate to a method, wherein the steps further include transmitting one or more alerts to the user when the user approaches the spending limit.

In some aspects, the techniques described herein relate to a computer readable non-transitory medium including computer executable instructions that, when executed on a processor, perform procedures including the steps of: retrieving financial information associated with a user; separating, after retrieval, the financial information into one or more categories; storing, by a processor, the financial information in a data storage unit; analyzing, by the processor, trends in the financial categories; generate, after analyzing the trends in the financial categories, a predictive model configured to determine a spending amount the user needs for a pay period wherein the predictive model includes a model of the user's future spending habits anticipated by a predetermined algorithm; updating, by the processor, the predictive model with new financial information associated with the user wherein the financial information has been retrieved and stored in the data storage unit; calculating, after applying the predictive model, a spending amount that that the user needs for the pay period; and allocating, after calculating the spending amount, the spending amount in the user's spending account for the pay period.

In some aspects, the techniques described herein relate to a computer-readable storage medium, wherein the steps further include transmitting one or more alerts to the user when the user approaches the spending limit.

In some aspects, the techniques described herein relate to a computer-readable storage medium, wherein prior to the generation of the predictive model, the steps further include: generating, in response to the analysis of the separate financial categories, one or more shadow models configured to predict a spending amount; updating, by a processor, the one or more shadow models with new financial information associated with the user; and integrating, by a processor, the shadow models into the predictive model to improve the accuracy of the predictive model.

In some aspects, the techniques described herein relate to a computer-readable storage medium, wherein the steps further include adjusting the spending limit based on information associated with future spending habits.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information and/or personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions and/or acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function and/or act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions and/or acts specified in the flowchart and/or block diagram block or blocks.

We claim:

1. A system for predictive modeling of a dynamic allocation of a spend account associated with a user, the system comprising:
a data storage unit configured to store financial information associated with a user; and
a processor configured to allocate a spending amount to the user for a payment period, wherein the processor is further configured to:
retrieve financial information associated with the user;
store, after retrieval, the financial information in the data storage unit;
separate, after storage, the financial information into one or more categories;
analyze, after separating the financial information into categories, one or more trends in the separated financial categories;
generate, after analyzing the trends in the financial categories, a predictive model configured to determine a spending amount the user needs for a pay period wherein the predictive model comprises a model of the user's one or more future spending habits anticipated by a predetermined algorithm;
update, by the processor, the predictive model with new financial information associated with the user wherein the financial information has been retrieved and stored in the data storage unit;
calculate, by a predetermined algorithm, a spending amount that that the user needs for the pay period; and
allocate, after calculating the spending amount, the spending amount to the user for the pay period.

2. The system of claim 1, wherein prior to the generation of the predictive model, the processor is configured to:
generate, in response to the analysis of the separate financial categories, one or more shadow models configured to predict a spending amount by a predetermined algorithm;
update the one or more shadow models with new financial information associated with the user; and
integrate the shadow models into the predictive model to improve the accuracy of the predictive model.

3. The system of claim 1, wherein the processor is further configured to retrieve information from one or more checking and savings accounts associated with the user from one or more banks associated with the user.

4. The system of claim 1, wherein after the spending amount has been allocated, the processor is further configured to create a savings account associated with the user based on the financial information associated with the user.

5. The system of claim 1, wherein the processor is further configured to retrieve information from third party applications associated with a financial history associated with the user.

6. The system of claim 1, wherein prior to allocating the spending amount, the processor is further configured to adjust the spending amount based on manual change done by the user.

7. The system of claim 1, wherein the processor is further configured to disallow the user from spending beyond the spending amount.

8. The system of claim 1, wherein the information associated with the user includes at least one selected from the group of marital status, children status, and education status.

9. A method for predictive modeling of a dynamic allocation of a spend account associated with a user, the method comprising the steps:
retrieving financial information associated with a user;
separating, after retrieval, the financial information into one or more categories;
storing, by a processor, the financial information in a data storage unit;
analyzing, by the processor, trends in the financial categories;
generate, after analyzing the trends in the financial categories, a predictive model configured to determine a spending amount the user needs for a pay period wherein the predictive model comprises a model of one or more future spending habits associated with the user anticipated by a predetermined algorithm;
updating, by the processor, the predictive model with new financial information associated with the user wherein the financial information has been retrieved and stored in the data storage unit;
calculating, after applying the predictive model, a spending amount that that the user needs for the pay period; and
allocating, after calculating the spending amount, the spending amount to the user for the pay period.

10. The method of claim 9, wherein prior to the generation of the predictive model, the steps further comprise:
generating, in response to the analysis of the separate financial categories, one or more shadow models configured to predict a spending amount;
updating, by a processor, the one or more shadow models with new financial information associated with the user; and
integrating, by a processor, the shadow models into the predictive model to improve the accuracy of the predictive model.

11. The method of claim 9, wherein the steps further comprise retrieving information from third party applications associated with a financial history associated with the user.

12. The method of claim 9, wherein the information associated with a user comprise at least one selected from the group of employment status, geographic location, and zip code.

13. The method of claim 9, wherein the financial information associated with the user comprises at least one selected from the group of debt information, prior transaction information, and spending pattern information.

14. The method of claim 9, wherein after allocating the spending amount, the steps further comprise creating a savings account associated with the user based on the information gathered.

15. The method of claim 9, wherein the steps further comprise retrieving information associated with future earnings.

16. The method of claim 9, wherein the steps further comprise transmitting one or more alerts to the user when the user approaches the spending amount.

17. A computer readable non-transitory medium comprising computer executable instructions that, when executed on a processor, perform procedures comprising the steps of:
retrieving financial information associated with a user;
separating, after retrieval, the financial information into one or more categories;
storing, by a processor, the financial information in a data storage unit;
analyzing, by the processor, trends in the financial categories;
generate, after analyzing the trends in the financial categories, a predictive model configured to determine a spending amount the user needs for a pay period wherein the predictive model comprises a model of one or more future spending habits associated with the user, the future spending habits being anticipated by a predetermined algorithm;
updating, by the processor, the predictive model with new financial information associated with the user wherein the financial information has been retrieved and stored in the data storage unit;
calculating, after applying the predictive model, a spending amount that that the user needs for the pay period; and
allocating, after calculating the spending amount, the spending amount in a spending account associated with the user for the pay period.

18. The computer-readable storage medium of claim 17, wherein the steps further comprise transmitting one or more alerts to the user when the user approaches the spending amount.

19. The computer-readable storage medium of claim 17, wherein prior to the generation of the predictive model, the steps further comprise:
generating, in response to the analysis of the separate financial categories, one or more shadow models configured to predict a spending amount;
updating, by a processor, the one or more shadow models with new financial information associated with the user; and
integrating, by a processor, the shadow models into the predictive model to improve the accuracy of the predictive model.

20. The computer-readable storage medium of claim 17, wherein the steps further comprise adjusting the spending amount based on information associated with future spending habits.
